(19) United States
(12) Patent Application Publication
(10) Pub. No.: US 2019/0233070 A1
(43) Pub. Date: Aug. 1, 2019

(54) CATENARY MODELING FOR A PLURALITY OF DEPLOYMENT LINES FOR AN OFFSHORE SEISMIC SYSTEM

(71) Applicant: Seabed Geosolutions B.V., Leidschendam (NL)

(72) Inventor: Martin John Hartland, Katy, TX (US)

(73) Assignee: Seabed Geosolutions B.V., Leidschendam (NL)

(21) Appl. No.: 16/333,208

(22) PCT Filed: Oct. 20, 2017
(86) PCT No.: PCT/US2017/057582

§ 371 Date: Mar. 13, 2019

Related U.S. Application Data
(60) Provisional application No. 62/412,174, filed on Oct. 24, 2016.

(51) Int. Cl. B63G 8/00; G01V 1/38

(52) U.S. Cl. CPC B63G 8/001; B63G 2008/007; B63B 2211/02; G01V 1/3843

(57) ABSTRACT

Embodiments, including systems and methods, for modeling the catenary shape of one or more deployment lines from a marine vessel, each of which is connected to a subsea device. A subsea device may include ROVs or other underwater vehicles and subsea cages, baskets, and similar devices that may be lowered or raised from the surface vessel. The disclosed system and method provides real-time modeling and predictive modeling of the catenary shape of the deployed lines based on input from one or more real time navigation sensors, as well as inputted parameters or values such as length of deployed cable, etc. This allows the surface vessel and/or ROV operators to maximize the position and speed of the surface vessel, ROV, and other subsea devices, and overall seismic node deployment and recovery operations, within the operational constraints of the system without causing cable failure or entanglement of the deployed lines.

### PRIORITY

This application claims priority to U.S. provisional patent application No. 62/412,174, filed on Oct. 24, 2016, the entire content of which is incorporated herein by reference.

### BACKGROUND OF THE INVENTION

### Field of the Invention

This invention relates to the catenary shape of deployed offshore lines, and more particularly to the shape of such lines when subsea equipment is deployed from a surface vessel, such as umbilicals, tethers, and basket wires connecting a ROV, basket, or other subsea equipment.

### Description of the Related Art

Marine seismic data acquisition and processing generates a profile (image) of a geophysical structure under the seafloor. Reflection seismology is a method of geophysical exploration to determine the properties of the Earth's subsurface, which is especially helpful in determining an accurate location of oil and gas reservoirs or any targeted features. Marine reflection seismology is based on using a controlled source of energy (typically acoustic energy) that sends the energy through seawater and subsurface geologic formations. The transmitted acoustic energy propagates downwardly through the subsurface as acoustic waves, also referred to as seismic waves or signals. By measuring the time it takes for the reflections or refractions to come back to seismic receivers (also known as seismic data recorders or nodes), it is possible to evaluate the depth of features causing such reflections. These features may be associated with subterranean hydrocarbon deposits or other geological structures of interest.

In general, either ocean bottom cables (OBC) or ocean bottom nodes (OBN) are placed on the seabed. For OBC systems, a cable is placed on the seabed by a surface vessel and may include a large number of seismic sensors, typically connected every 25 or 50 meters into the cable. The cable provides support to the sensors, and acts as a transmission medium for power to the sensors and data received from the sensors. One such commercial system is offered by Sercel under the name SeaRay®. Regarding OBN systems, and as compared to seismic streamers and OBC systems, OBN systems have nodes that are discrete, autonomous units (no direct connection to other nodes or to the marine vessel) where data is stored and recorded during a seismic survey. One such OBN system is offered by the Applicant under the name MANTA®. For OBN systems, seismic data recorders are placed directly on the ocean bottom by a variety of mechanisms, including by the use of one or more of Autonomous Underwater Vehicles (AUVs), Remotely Operated Vehicles (ROVs), by dropping or diving from a surface or subsurface vessel, or by attaching autonomous nodes to a cable that is deployed behind a marine vessel.

Autonomous ocean bottom nodes are independent seismometers, and in a typical application they are self-contained units comprising a housing, frame, skeleton, or shell that includes various internal components such as geophone and hydrophone sensors, a data recording unit, a reference clock for time synchronization, and a power source. The power sources are typically battery-powered, and in some instances the batteries are rechargeable. In operation, the nodes remain on the seafloor for an extended period of time. Once the data recorders are retrieved, the data is downloaded and batteries may be replaced or recharged in preparation of the next deployment. Various designs of ocean bottom autonomous nodes are well known in the art. See, e.g., U.S. Pat. No. 9,523,780 (citing patents and publications), incorporated herein by reference. Still further, the autonomous seismic nodes may integrated with an AUV such that the AUV, at some point subsea, may either travel to or from the seabed at a predetermined position. See, e.g., U.S. Pat. No. 9,090,319, incorporated herein by reference. In general, the basic structure and operation of an autonomous seismic node and a seismic AUV is well known to those of ordinary skill.

A general seismic deployment and survey operation generally require one or more surface vessels that deploy and/or retrieve autonomous seismic nodes from the ocean bottom. See, e.g., U.S. Pat. No. 9,090,319, incorporated herein by reference. Generally, a deployment vessel stores a plurality of autonomous seismic nodes, and one method of deployment utilizes a ROV as well as a separate basket to hold some of the seismic nodes, each which is lowered to a subsea position and connected to a surface vessel by a deployment line, such as an umbilical, tether, or wire. As is known in the art, one or even two ROVs may be used to deploy nodes to the ocean bottom. See, e.g., U.S. Pat. Nos. 6,975,560; 7,210,556; and 8,611,181, each incorporated herein by reference. One conventional method is to deploy a ROV in a body of water while also deploying a separate underwater node transfer device, such as a cage or basket or skid that is configured to hold a plurality of autonomous seismic nodes and be lowered and raised from a surface vessel. At a certain subsea position, the ROV docks or mates with the node transfer device and transfers one or more nodes from the node transfer device to the ROV. The ROV then places the retrieved nodes at one or more positions on the seabed. Prior art patents and publications illustrating this method include at least the following: U.S. Pat. Nos. 6,975,560; 7,210,556; 7,324,406; 7,632,043; 8,310,899; 8,611,181; 9,415,848, and U.S. Patent Application Publication Nos. 2006/0159524; 2015/0284060; 2016/0121983, each of which is incorporated herein by reference.

As is known in the art, these deployment lines have a catenary shape in the water, that is, each line (or a portion thereof) has a curve (such as a U-shaped curve) in the water connecting the subsea equipment to the surface vessel. The catenary shape may have many different shapes based on a variety of different factors, including the type of subsea equipment deployed, water conditions, wave currents, cable tension, speed of vessel, speed of subsea equipment, etc.

The catenary shape of the deployed line provides numerous operational constraints for the deployment system. For example, the deployment lines for separate subsea equipment do not need to cross or touch each other, so their relative position is necessary. As another example, the cable tension of the deployment line has a maximum operating tension, and high-efficiency operations require maximizing the tension and capabilities of the deployment line without exceeding any operational constraints.

In short, the need for increased speed and efficiency for subsea operations requires a greater knowledge of the catenary shape of the deployment lines, particularly as many operations may require two or more ROVs used simultaneously and existing subsea operations are going to greater depths (such as 3000 meters or more), which have more complex catenary shapes. However, there are no commercially available products that model the catenary shape of deployment lines for subsea equipment. Currently, most ROVs (and tether management systems for an ROV) use a camera system mounted on the ROV, which allows the ROV operator to visually inspect the cable tension on the deployment line. In general, the ROV operator performs subsea operations with the ROV and if the deployment line appears to be too tight, the ROV may be braked, paused, or slowed down to prevent excess cable tension. While this method works for some operations, high speed operations and operations at large depths requires greater knowledge of the deployment line and predictive modeling of the catenary shape to maximize the subsea operations.

ORCINA has a product named OrcaFlex for time domain fine element analysis of some subsea operations, the product literature and mathematical modeling techniques which are incorporated herein by reference. Fugro has a similar product named Deepworks Live. IONGEO provides a basic seabed profile in their Integrated Navigation Systems (INS). Prior INS systems have been used for limited modeling of a fixed anchor and anchor line dropped for a surface vessel in shallow waters. For example, U.S. Patent Publication No. 2013/0239649, incorporated herein by reference, discloses a method of determining the tension in a mooring line. However, existing commercially available Integrated Navigation Systems (INS) do not provide the ability to visualize the catenary shape of deployed lines (such as umbilicals, tethers, and basket wires) used in an offshore environment in real time. Further, existing INS systems do not predict in advance what a catenary problem may look like ahead of time and/or predictive modeling.

A need exists for an improved method and system for predictive and real-time monitoring of the catenary shape of deployed lines in an offshore marine environment. This need exists not only in ocean bottom seismology when using ROVs but also in any other offshore context when using ROVs or other subsea equipment.

### SUMMARY OF THE INVENTION

Embodiments, including systems and methods, for modeling the catenary shape of one or more deployment lines from a marine vessel, each of which is connected to a subsea device. A subsea device may include ROVs or other underwater vehicles and subsea cages, baskets, and similar devices that may be lowered or raised from the surface vessel. The disclosed system and method provides real-time modeling and predictive modeling of the catenary shape of the deployed lines based on input from one or more real time navigation sensors, as well as inputted parameters or values such as length of deployed cable, etc. This allows the surface vessel and/or ROV operators to maximize the position and speed of the surface vessel, ROV, and other subsea devices, and overall seismic node deployment and recovery operations, within the operational constraints of the system without causing cable failure or entanglement of the deployed lines.

Disclosed is a method for the deployment of subsea equipment from a surface vessel, comprising deploying a first subsea equipment from a surface vessel, wherein the first subsea equipment is connected to the surface vessel by a first deployment line, modeling a catenary shape of the first deployment line, and determining one or more operating parameters for the surface vessel based on the modeled catenary shape. The method may further comprise deploying a second subsea equipment from the surface vessel, wherein the second subsea equipment is connected to the surface vessel by a second deployment line, deploying a third subsea equipment from the surface vessel, wherein the third subsea equipment is connected to the surface vessel by a third deployment line, and modeling a catenary shape of the second and third deployment lines. In one embodiment, the first subsea equipment is an ROV configured to deploy a plurality of autonomous seismic nodes on the seabed. the second subsea equipment is a second ROV, and the third subsea equipment is a basket configured to hold a plurality of autonomous seismic nodes. The method may further comprise determining one or more operating parameters for the subsea device or the surface vessel based on the modeled catenary shape(s) of any one or more of the deployment lines. The method may further comprise outputting a modeled catenary shape to an Integrated Navigation System (INS) on the marine vessel for real-time visualization of the deployment lines. The method may further comprise measuring a plurality of characteristics of each of the deployment lines, wherein the modeled catenary shape is based on the measured plurality of characteristics of a deployment line. For example, the plurality of characteristics may comprise cable tension, cable length, or cable position. The method may further comprise determining the catenary shape based on a plurality of subsea conditions as monitored by a plurality of subsea sensors. The method may further comprise positioning the subsea equipment or the surface vessel based on the modeled catenary shape. In one embodiment, the one or more operating parameters comprises surface vessel speed or heading. In one embodiment, the modeled shape is a real-time position or a predicted position of a plurality of points of the deployment line.

Also disclosed is a method for the deployment of autonomous seismic nodes to the seabed, comprising deploying a first unmanned underwater vehicle (UUV) from a surface vessel, wherein the first UUV is connected to the surface vessel via a first deployment line, deploying a subsea basket configured to hold a plurality of autonomous seismic nodes from the surface vessel, wherein the subsea basket is connected to the surface vessel via a second deployment line, modeling a real-time catenary shape of the first and second deployment lines, and determining one or more operating conditions for the surface vessel based on the modeled catenary shape of the first and second deployment lines. The method may further include at least one characteristic of the catenary trajectory formed by the first and second deployment lines. The method may further include comparing the one or more operating conditions with a corresponding boundary condition of the surface vessel. The method may further comprise modeling a profile of the seabed and analyzing the modeled catenary shapes of the first and second deployment lines in relation to the seabed profile.

Also disclosed is a method of modeling a catenary shape of a deployment line, the method comprising measuring one or more characteristics of a deployment line, wherein the deployment line is connected to an unmanned underwater vehicle (UUV) and a surface vessel; inputting one or more subsea conditions, and modeling a real-time catenary shape of the deployment line based on the measured characteristics and inputted subsea conditions. The method may further include determining one or more characteristics of the deployment line based on the modeled catenary shape of the deployment line.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 illustrates one embodiment of a subsea seismic deployment operation.

FIGS. 2A-2C illustrate various views of one embodiment of a subsea seismic deployment operation.

FIG. 3 illustrates one embodiment of a method for modeling the catenary shape of a deployment line for a subsea deployment operation.

FIG. 4 illustrates one embodiment of a method for modeling the catenary shape of a deployment line for a subsea deployment operation.

### DETAILED DESCRIPTION

Various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure. The following detailed description does not limit the invention.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures, or characteristics may be combined in any suitable manner in one or more embodiments.

### SYSTEM AND OPERATION

As mentioned above, prior art Integrated Navigation Systems (INS) do not provide the ability to visualize the catenary shape of deployed lines (such as umbilicals, tethers, and basket wires) used in an offshore environment in real time, in particular deployment lines for ROVs for seismic operations. Further, existing INS systems do not predict in advance what a catenary problem may look like ahead of time and/or provide predictive modeling of the catenary profiles. The need for increased speed and efficiency for subsea operations requires a greater knowledge of the catenary shape of the deployment lines, particularly for some types or depths of subsea operations.

Knowing the real time catenary shape of the deployment line (or plurality of deployment lines) provides many advantages. One commercial advantage is the ability to avoid letting out too much tether or cable to the lowered subsea equipment. Another advantage is to keep the tether management system (TMS) at the optimal depth. Still another advantage is for orientating the surface vessel heading (as well as control and operation of the subsea equipment connected to the deployment line) to give the best possible separation of the different subsea systems lowered from the surface vessel. The deployed line and deployed subsea equipment situation changes significantly depending on currents, tides, vessel speed/direction, vessel rate of turn, ROV speed/direction, seafloor terrain, subsea hazards, etc.

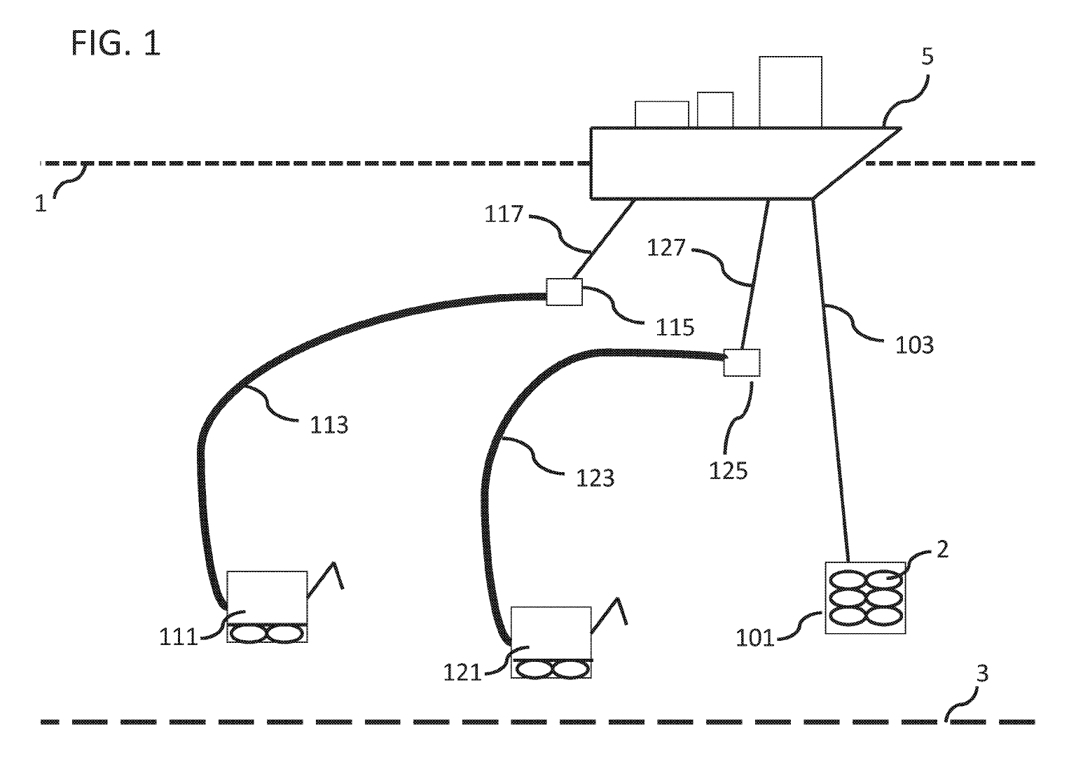

FIG. 1 shows one example of a subsea deployment operation for a plurality of seismic nodes. In one embodiment, surface vessel 5 is located on water surface 1 and is configured to deploy a plurality of ROVs from the surface vessel, such as two, three, four, five, or six or more ROVs. For simplicity purposes, FIG. 1 only shows two ROVs deployed from the vessel, although many more ROVs are possible based on this disclosure. In one embodiment, surface vessel 5 is located on water surface 1 and is configured to deploy first ROV 111, second ROV 121, and subsea basket 101 on or near seabed 3.

In one embodiment, each ROV may be the FUGRO FCV3000, but other similar ROVs can be used as well. In general, the structure and operation of marine ROVs are well known to those of ordinary skill. For example, Publication No. WO2014/090811, incorporated herein by reference, describes a ROV configured to deploy and retrieve autonomous seismic nodes to the seabed with a separate AUV configured to monitor and exchange data with the seismic nodes. Likewise, U.S. Pat. No. 8,075,226, incorporated herein by reference, describes a ROV configured to physically deploy autonomous seismic nodes from a carrier located on the ROV as well as a basket lowered by a surface vessel and to mechanically connect the ROV to the lowered basket to transfer nodes from the basket to the ROV carrier. In other embodiments, an autonomous underwater vehicle (AUV) or other unmanned underwater vehicle (UUV) may be used instead of an ROV. Likewise, the structure and operation of an AUV is well known to those of ordinary skill. For example, Applicant's U.S. Pat. No. 9,090,319, incorporated herein by reference, discloses one type of autonomous underwater vehicle for marine seismic surveys. Applicant's U.S. Publication No. 2016/0121983, incorporated herein by reference, discusses the general components and configurations of ROVs and seismic AUVs, incorporated herein by reference. Of course, one of skill in the art realizes that the AUV or UUV (or ROV) for deploying seismic nodes to the seabed need not have any seismic sensors itself. While various ROVs, UUVs, or AUVs may be used with the embodiments presented in this disclosure, the invention is not limited to any particular underwater vehicle or configuration thereof to deploy the autonomous seismic nodes on the seabed.

The surface vessel also deploys subsea cage/basket 101 to a position on or near the seabed, or at some position subsea between the surface vessel and the seabed. In some embodiments, two or more subsea baskets may be deployed from the vessel. Subsea basket 101 may be located near the surface, at a subsea position between the seabed and the surface, near the seabed, or on the seabed. In one embodiment, the ROV and/or subsea basket may be moving in the body of water with a first speed based on movement of the ROV, movement of the vessel, and/or current movement. As is known in the art, first ROV 111 is coupled to first TMS 115 via tether 113 and second ROV 121 is coupled to second TMS 125 via tether 123, with first TMS 115 being coupled to surface vessel 5 via umbilical cable 117 and second TMS 125 being coupled to surface vessel 5 via umbilical cable 127. Additional ROVs may be similarly coupled to the surface vessel, each with a corresponding tether, TMS, and umbilical cable/line. In general, for the purposes of this disclosure, some or all of the portions of an ROV's tether and/or umbilical cable may be generally considered as the ROV's deployment line. As is known in the art, the tether management system (TMS) is coupled to the ROV during lowering and/or raising of the ROV through the splash zone from the surface vessel. The TMS has a tether winch that may length and/or shorten the tether as appropriate. The umbilical cable provides power and data signals between the surface vessel and the TMS. The TMS relays data signals and/or power for the ROV through the tether line.

Basket/cage 101 may be lowered from surface vessel 5 via wire/cable 103 with a plurality of autonomous seismic nodes 2 (or other seismic payload devices) stored on the basket/cage for transfer with the ROV(s), such as disclosed in U.S. Pat. No. 6,975,560 and U.S. Patent Publication No. 2016/0121983, each incorporated herein by reference. Each ROV may be used to transfer seismic nodes 2 from cage 101 and deploy those seismic nodes to seabed 3 at predetermined positions. In one embodiment as shown in FIG. 1, the ROV may have a skid or other node storage system for storing a plurality of autonomous seismic nodes on the ROV. Node storage system may be located on an underside of the ROV or may be located on a front, back, or side portion of the ROV. In the embodiment shown in FIG. 1, each of the ROVs has a plurality of nodes stored on a skid coupled to the ROV. In some embodiments, the nodes may be stored and/or handled by a plurality of grabbers, grippers, manipulators, or other single node handling devices, as described herein. For example, each ROV may hold a plurality of autonomous seismic nodes by any number of mechanisms, such as a robotic arm manipulator, a cage, basket, conveyor, or skid, as described in U.S. Pat. Nos. 6,975,560, 7,210,556, and 8,611,181, and U.S. Patent Publication Nos. 2006/0159524 and 2016/0121983, each incorporated herein by reference. Likewise, the ROVs may dock with and/or couple to the basket by a wide variety of mechanisms, such as by one or more docking probes as described in U.S. Pat. Nos. 6,975,560 and 9,415,848, each incorporated herein by reference. Thus, in one embodiment, the ROV may have a docking system used to dock and/or mate with the subsea basket 101, which may or may not have a corresponding collar or docking mechanism to mate with the docking system of the ROV. In one embodiment, the ROVs and subsea basket 101 each comprise acoustic modems that are configured to communicate with each other or the surface vessel via acoustic communications. The present disclosure is not limited to any particular node holding device or node transfer device or basket coupling device. In other words, the nodes may be transferred to and from the baskets and the ROVs (and/or from the baskets to the seabed) in any number of configurations. In other embodiments, an autonomous underwater vehicle (AUV) or unmanned underwater vehicle (UUV) may be used instead of an ROV.

In one embodiment, each ROV and TMS is coupled with a beacon or transponder so that the surface vessel knows the position of each ROV and TMS. Likewise, the subsea basket/cage 101 may be equipped with a transponder or beacon such that its position may also be known. Because the surface vessel's position is known, the surface vessel knows at least the beginning position and the end position of each deployment line. For the purposes of this disclosure, the deployment line of an ROV may be considered (i) the tether portion from the ROV to the TMS, (ii) the umbilical portion from the TMS to the surface vessel, or (iii) the cable portion from the ROV to the surface vessel (which may itself be formed of multiple cables/lines, such as a tether portion and an umbilical cable portion). Various sensors, devices, inputs, etc. may be coupled to an Integrated Navigation System (INS) on the surface vessel or a Dynamic Positioning (DP) system for the ROV on the surface vessel or the ROV itself. In one embodiment, the length of the deployment line (whether from the TMS to the surface vessel or from the ROV to the TMS) is known. In one embodiment, the length of the tether line may be approximately 1200 meters, which increases the layback of the TMS and increases subsea separation of the ROVs. The surface vessel speed, heading, range, bearing may also be known. The current profile may also be known (whether based on measured profiles or estimates). The tension of each deployment line may be measured or predicted. In some embodiments, real time sensors utilized may include but not be limited to USBL beacon positions, vessel gyroscopes, ROV gyroscopes, Doppler velocity logs (DVL), current profilers, echo sounders, and motion reference units (MRUs). In still other embodiments, the pre-survey data and/or seabed profile may be inputted into the DP system, INS, and/or modeling software for a better predictive analysis of different subsea parameters, including a catenary shape of the deployment lines.

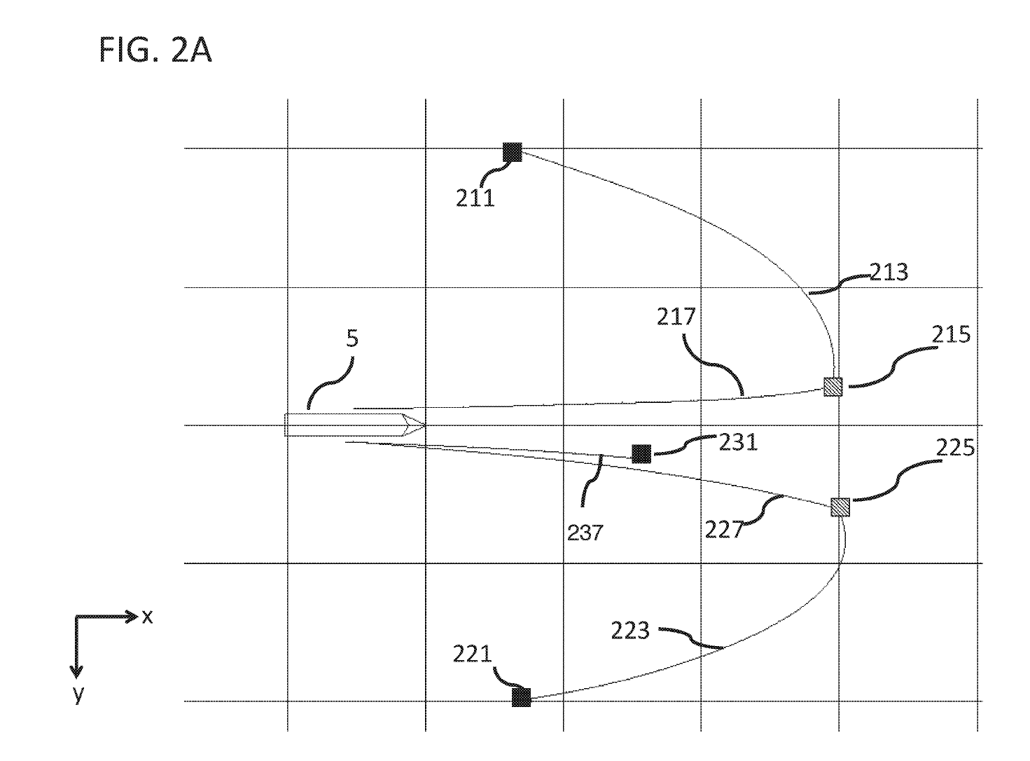

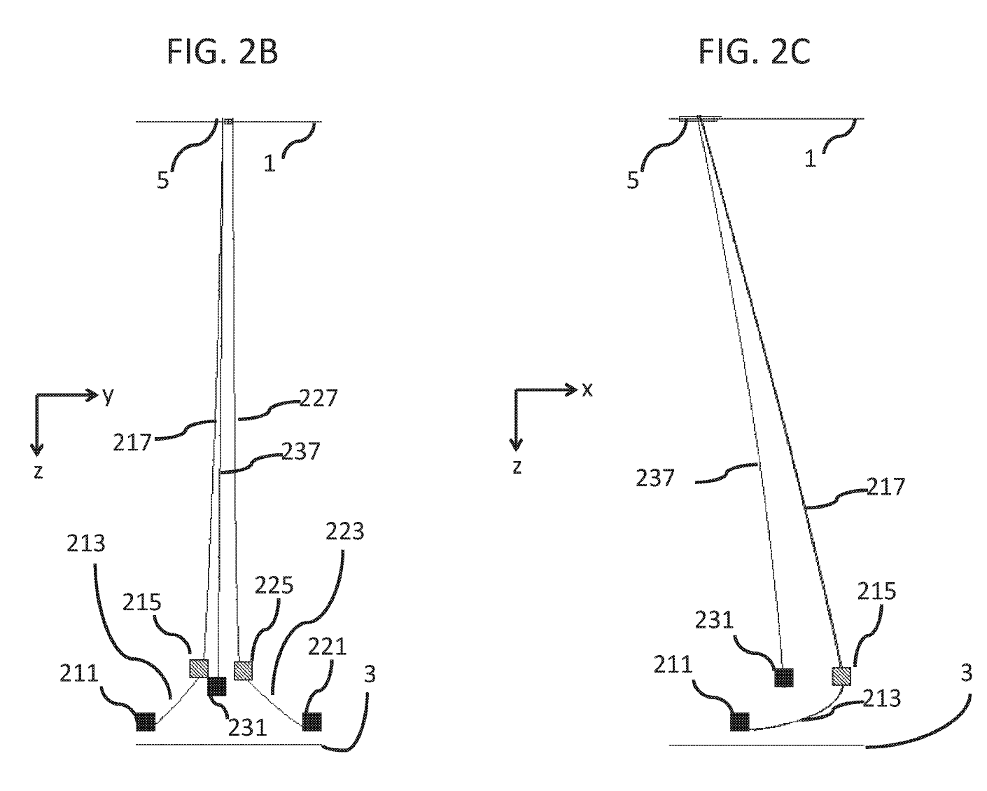

FIGS. 2A-2C illustrate various views of one embodiment of a subsea seismic deployment operation, and in particular the position of various subsea equipment and the catenary shape of the deployment lines connecting the subsea equipment to a surface vessel. FIG. 2A shows a subsea deployment system from a top or aerial perspective, FIG. 2B shows the subsea system from FIG. 2A from a subsea rear perspective, and FIG. 2C shows the subsea system from FIG. 2A from a subsea side perspective. The subsea seismic deployment system shown in FIGS. 2A-2C may be substantially similar to the system shown in FIG. 1 and may include first ROV 211 coupled to surface vessel 5 via tether 213, TMS 215, and umbilical line 217, second ROV 221 coupled to surface vessel 5 via tether 223, TMS 225, and umbilical line 227, and cage/basket/skid 231 (or other subsea device) coupled to surface vessel 5 via deployment line 237. More or less ROVs may be used. In general, the entire cable portion from the ROV to the surface vessel is generically referred to as a deployment line. As shown in FIGS. 2A-2C, the tether portion of the deployment line (such as tether sections 213 and 223) has increased drag and/or shape as opposed to the umbilical portion of the deployment line (such as umbilical sections 217 and 227).

As shown in FIG. 2A, first ROV 211 may operate on one side of the surface vessel and second ROV 221 may operate on the other side of the surface vessel. In this operation, the surface vessel may be travelling backwards with the cage 101 towed behind (or underneath) the vessel such that the ROVs travel back and forth to cage 101 (in a staggered or “out of phase” sequence) to retrieve the autonomous seismic nodes. The illustrated grid spacing in FIG. 2A is approximately 100 meters. In one embodiment, each ROV may travel approximately 500 meters laterally from the surface vessel (with a corresponding 1000 meter tether). In other embodiments, the maximum lateral excursion may be 1000 meters or more from the surface vessel (such as with a 1500 meter tether). In other embodiments, draft coefficients on the tethers can be improved using well-known methods to increase the overall lateral excursions of the ROV. The TMS for each ROV is located a relatively small lateral distance from the surface vessel, as shown in FIG. 2A, and is positioned to avoid entanglement with the other ROVs. During travel from the basket to the intended seabed destination, the path of the ROV minimizes travel but also minimizes the change for entanglement with the adjacent ROV deployment lines. During travel back to the basket for node reloading, the ROV may travel along the path of the deployment line to the TMS to minimize the change of wire entanglement. In one embodiment, the ROVs deploy all of the required seismic nodes for a particular seismic receiver line before travelling to the next receiver line. In other embodiments, each ROV travels in a substantially linear direction in the x coordinate (with the path of the surface vessel) so that four, six, or eight seismic nodes are placed about the same time on a receiver line before traveling towards the next receiver line in the general path of the surface vessel heading.

As shown in FIGS. 2A-2C, each deployment line has a catenary shape in the sea, a shape that may be modeled by a software system based on multiple variables as described herein. While the catenary shape of FIGS. 2A-2C is fairly simple, complex seabed profiles and current profiles may increase the complexity of the catenary shapes. As the ROVs operate and the surface vessel changes position and/or speed, the deployment lines have a greater chance of entanglement. Further, complicated subsea operations and increased efficiencies also increase the chance of entanglement of the deployment lines, thereby requiring greater precision of the ROVs which requires a greater knowledge of the catenary shape of the deployment lines.

FIG. 2B shows the subsea system from FIG. 2A from a subsea rear perspective. In this embodiment, each ROV is substantially at the same position as each other from a longitudinal (x) and depth (z) position and they differ only in a lateral (y) position. As illustrated, each deployment line (whether the wire for the basket, the umbilical cable for the TMS, or the tether for the ROV) has a catenary shape, the position of which needs to be monitored to avoid entanglement of the cables/wires. In one embodiment, the surface vessel and ROVs are constantly moving to deploy seismic nodes and to avoid entanglement of the lines. The TMS units for each ROV may be positioned a longitudinal distance (x) from the cage to avoid entanglement, which may be different for each TMS unit. Likewise, FIG. 2C shows the subsea system from FIG. 2A from a subsea side perspective. As shown in this view, only a single ROV 211 is shown, as they both have the approximate same longitudinal x position.

In operation at any given time, the ROVs may be at different x, y, z positions during their movement between the cage and the intended seabed positions. In other words, FIGS. 2A-2C only illustrate one snapshot of one potential view of the placement of the ROVs during a sample operation. The use of additional ROVs, greater operating depths, and different operating positions would increase the complexity of the catenary profiles of the deployment lines. If other subsea devices are used besides ROVs and baskets, each deployment line for the subsea device would have a unique catenary profile.

### MODELING A CATENARY PROFILE OF THE DEPLOYMENT LINES

As described above, the present disclosure allows a surface vessel to operate one or more ROVs (and other subsea devices) in a much more efficient manner based in part on knowing and/or modeling the catenary shape of each ROV's deployment line (e.g., the tether and/or umbilical cable). Prior art Integrated Navigation Systems (INS) do not provide the ability to visualize the catenary shape of deployed lines (such as umbilicals, tethers, and basket wires) used in an offshore environment in real time, in particular deployment lines for ROVs for seismic operations. Further, existing INS systems do not predict in advance what a catenary problem may look like ahead of time and/or predictive modeling. The need for increased speed and efficiency for subsea operations requires a greater knowledge of the catenary shape of the deployment lines, particularly for some types or depths of subsea operations, and in particular for a high number of ROVs operating simultaneously.

Based on the known positions of the deployment line and various other inputs (such as length of the deployment line, surface vessel operation conditions, current, etc.), a catenary shape of the deployment line can be modeled in real time or near real time. In some embodiments, a predictive model of the catenary shape of the deployment lines may be calculated or determined based on the anticipated position of the ROVs, cage, and surface vessel. The modeled catenary shape may also determine the tension of one or more points of the deployment line. In still other embodiments, real time sensors utilized may include but not be limited to USBL beacon positions, vessel gyroscopes, ROV gyroscopes, Doppler velocity logs (DVL), current profilers, echo sounders, and motion reference units (MRUs). In still other embodiments, the pre-survey data and/or seabed profile may be inputted into the modeling software for a better predictive analysis of the catenary shape. In still another embodiment, the seabed profile and/or terrain may be combined with the described modeling system of the subsea vessels and catenary shapes of the deployment lines for better navigation in relation to the seabed and subsea obstacles. This real-time and predictive modeling technology and capability is not used for ocean bottom seismic deployment operations and provides a significant advancement over prior art visualization and/or modeling techniques for seismic seabed operations.

In one embodiment, the disclosed system and method utilizes standalone time domain finite element (FE) software with a traditional INS to provide a navigation desk for the surface vessel and/or lowered equipment (e.g., ROV, UUV, TMS, subsea basket, etc.) with a real time view of the catenary shape of the deployed lines based on input from one or more real time navigation sensors. In one embodiment, the real time sensors utilized may include but not be limited to USBL beacon positions, vessel gyroscopes, ROV gyroscopes, Doppler velocity logs (DVL), current profilers, echo sounders, and motion reference units (MRUs), as well as inputted parameters or values such as length of deployed cable, etc. In some embodiments sensors may be placed at various positions on the deployment line itself to provide additional guidance as to the position of the deployment line. In an additional embodiment, the disclosed system provides the capability to predict and/or model in advance what a catenary shape and/or problem will look like ahead of time based upon a variety of parameter values. In one embodiment, the parameter values may be obtained from one or more of the real time sensors. In one embodiment, the software and predictive guidance system utilized may be similar to the modeling system for cable and node touchdown on the ocean bottom as described in more detail in Applicant's U.S. Patent Publication No. 2016/0124105, incorporated herein by reference. In one embodiment, a linear or parabolic equation fit or other similar mathematical formulas may be utilized (e.g., a least squares analysis) by one or more computer simulations using standalone time domain finite element (FE) software as is known in the art. In one embodiment, the disclosed modeling techniques utilize formulas similar to those utilized in the commercially available OrcaFlex software, incorporated herein by reference. In one embodiment, the disclosed method and system calculates the catenary shape of a plurality of deployment lines from the same surface vessel for a real-time modeling and predictive modeling of the plurality of deployment lines. This allows the surface vessel and/or ROV operators to maximize the speed and position of the vessel and ROV within the operational constraints of the system without causing cable failure or entanglement.

Knowing the real time catenary shape of the deployment line (or plurality of deployment lines) provides many advantages. One commercial advantage is the ability to avoid letting out too much tether or cable to the lowered subsea equipment. Another advantage is to keep the tether management system (TMS) at the optimal depth. Still another advantage is for orientating the surface vessel heading (as well as control and operation of the subsea equipment connected to the deployment line) to give the best possible separation of the different subsea systems lowered from the surface vessel. The deployed line and deployed subsea equipment situation changes significantly depending on currents, tides, vessel speed/direction, vessel rate of turn, ROV speed/direction, seafloor terrain, subsea hazards, etc.

In one embodiment, results from the catenary modeling system can be provided to a Navigation Room on the surface vessel, which allows the operators of the ROV and/or surface vessel to know the real time and/or predictive modeling of the catenary shapes of the deployed lines. The Navigation Room is effectively the Command and Control system for the deployed equipment and surface vessel. By providing the simulation results to the Navigation Room and/or command station, the decision making of the ROV and/or surface vessels operations can be greatly improved. The operations can be optimized for maximum efficiency with greatest chance of avoiding ROV entanglement with deployment lines. In one embodiment, the disclosed system and/or method presents ROV pilots knowledge about their environment beyond what is visible from their ROV cameras, enabling continuous and safe operation in low visibility conditions and in areas of complex subsea infrastructure. For example, introducing what is over the horizon into the ROV pilot's view reduces the risk of collision and increases the speed with which the ROV pilot can deploy nodes in high density environments. In one embodiment, the disclosed system and method provides proximity models, warnings, and 3D visualization techniques, each of which mitigates risks associated with working around offshore platforms, subsea infrastructure, geological hazards, and international borders.

In one embodiment, the disclosed system and method is configured to determine the catenary position of a plurality of deployment lines at the same time in the same general area (such as from the same surface vessel). Such a multi-catenary calculation is not disclosed in the prior art. In view of such calculations, the disclosed system is configured to determine the boundary conditions of the surface vessel (such as vessel speed, bearing, etc.) for optimal efficiency and speed of moving the subsea equipment for the particular subsea operation (such as the deployment of a plurality of seismic sensors). In another embodiment, the disclosed method models multiple elements of the deployment lines, such as real time and predicted catenary shape and cable tension, and in combination with subsea sensor inputs the catenary shapes are output into a navigation system on the marine surface vessel for real time visualization and analysis to more efficiently and quickly conduct the subsea operations, such as when deploying a plurality of seismic sensors on the seabed by a plurality of ROVs.

It is helpful to know the seafloor contour and identified seafloor hazards when operating an ROV. In one embodiment, maximizing the efficiency of any subsea device deployment and modeling of catenary lines requires visualizing realistically and in-real time the seabed terrain and subsea hazards. In one embodiment, the disclosed method utilizes the seafloor contour and identified seafloor hazards to provide real-time visualizations when operating in and around hazards and challenging seabed terrain. For example, digital terrain maps of the project area may be acquired with Multi Beam Echo Sounder (MBES) and/or Light Imaging, Detection, And Ranging (LIDAR) techniques and provided in an x, y, z format that can be imported into the modeling software and/or provided to the INS system and ROV operator to further enhance operational awareness. In one embodiment, an integrated MBES and LIDAR digital terrain map of the seismic project area is provided to the INS system that is combined with and/or loaded into the real-time catenary modelling system described herein. Thus, the disclosed method and system may include modeling of the seabed and other subsea hazards in combination with modeling of any subsea devices and deployment lines and determining an intended operating parameter of the surface vessel, deployment line, and/or subsea device based on an analysis of the seabed terrain.

In one embodiment, the ROV operator is displayed with 2D and 3D map views with Electronic Navigation Chart (ENC) backgrounds interfaced with 2D or 3D views of the seabed and/or subsea with real-time and/or predictive modeling of the subsea devices and deployment lines. These 2D or 3D views can be seen on displays on the marine vessel or monitored on the web for fast decision making, project management, and client supervision. Further, the disclosed system and use of predictive modeling allows forces, tensions, velocities, sea states, currents, and cable catenaries to be modelled in advance and thereby allows a ROV pilot to rehearse the mission at a full ROV console. This realistic training mode detects and mitigates potential hazards, simultaneous operations capability and operating range long before the ROV is in the water.

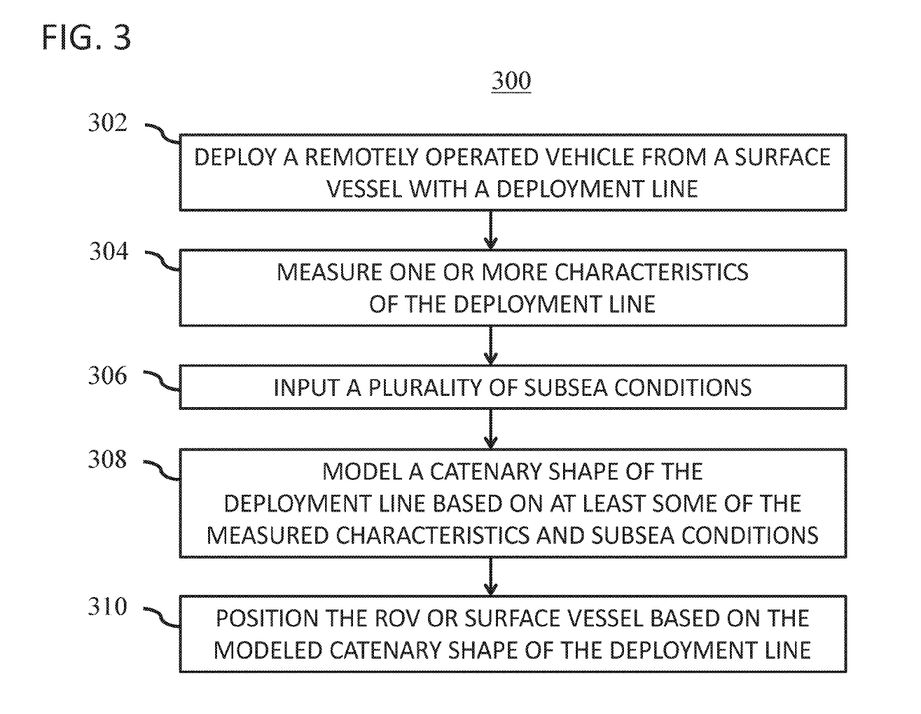

FIG. 3 illustrates one embodiment of a method 300 for modeling the catenary shape of a deployment line for a subsea seismic deployment operation. In some embodiments, this method may be used for modeling a plurality of deployments lines at the same time. Step 302 comprises deploying one or more ROVs from a surface vessel with a deployment line. Two or more ROVs may be deployed, as well as one or more baskets with autonomous seismic nodes on the basket. In other embodiments, a UUV or other subsea device may be deployed with the deployment line instead of an ROV. Step 304 comprises measuring one or more characteristics of the deployment line connecting the ROV to the surface vessel. The characteristics may be position, tension, angle, etc. In some embodiments, a plurality of positions or characteristics are measured, such as the measured positions of the ROV and TMS (via beacons or transponders) and surface vessel, and in some embodiments it may include other positions on the deployment line via one or more sensors or other techniques. Step 306 comprises inputting a plurality of subsea conditions, such as current profile, seabed profile, etc. Data from other sensors may also be inputted, and other estimates as to cable tensions and other parameters may be used. Step 308 comprises modeling a catenary shape of the deployment line based on at least some of the measured characteristics and/or subsea conditions. This can be a real time or near-real time modeling or predictive modeling of the catenary shape. In one embodiment, various operating parameters of the surface vessel and/or ROV may be inputted into the modeling software for increased accuracy of the catenary shape of the deployment lines. In some embodiments, the model may vary the surface vessel spread, heading, range, etc. to determine the optimal positioning of the ROV and/or surface vessel. In some embodiments, the ROV or surface vessel may be positioned based on the modeled catenary shape of the deployment line, as shown in step 310. This process is continually repeated during the duration of the ROV operations. In other words, as long as the ROVs are operating at a subsea position(s), in one embodiment the catenary shapes of the deployment lines are repeatedly modeled and optimal positions and movements of the subsea devices and/or surface vessels are continually generated.

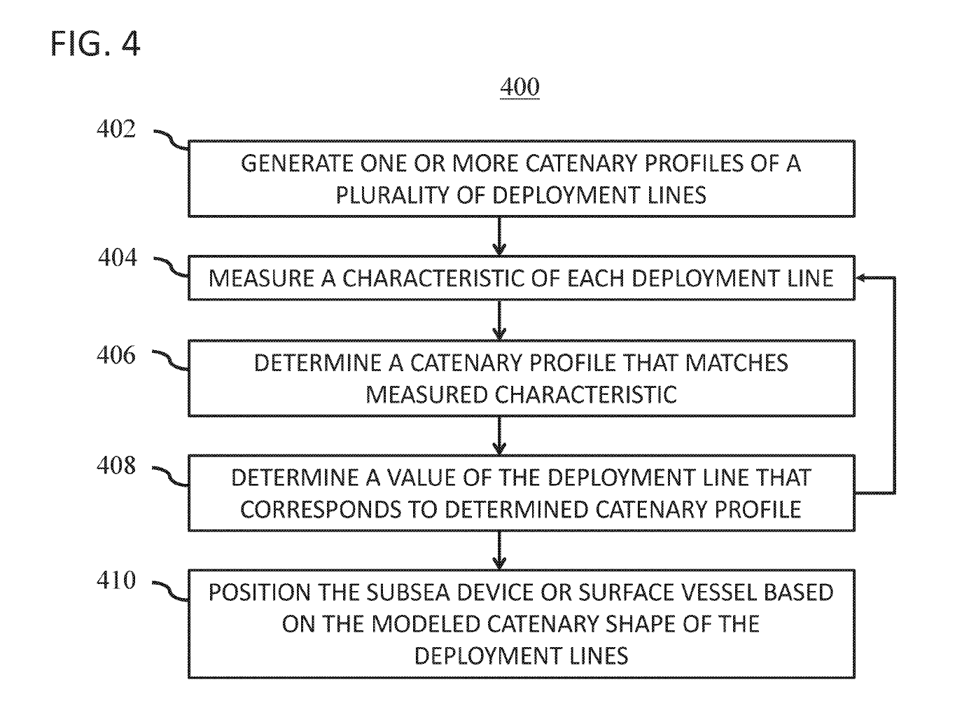

FIG. 4 illustrates one embodiment of a method 400 for modeling the catenary shape of a deployment line for a subsea deployment operation. Step 402 comprises generating one or more catenary profiles of a plurality of deployment lines. This may include a set or range of catenary profiles or trajectories for each deployment line. This initial profile may be as simple as determining the position of ROV and surface vessel (as well as the TMS unit) and plotting a simple catenary shape based on those values. The deployment lines may be to any number of subsea devices, such as an ROV, UUV, cage, basket, etc. Step 404 comprises measuring a characteristic of each of the plurality of deployment lines. The characteristic may be a tension, angle, position, etc. of one or more portions or points of the deployment line, or other characteristics as detailed herein. In other embodiments, the characteristics may be inputted (based on assumed, estimated, or known measurements) instead of actively measured. In still other embodiments, one or more subsea conditions may be inputted (e.g., current profile, etc.). In one embodiment, the real time sensors utilized may include but not be limited to USBL beacon positions, vessel gyroscopes, ROV gyroscopes, Doppler velocity logs (DVL), current profilers, echo sounders, and motion reference units (MRUs), as well as inputted parameters or values such as length of deployed cable, etc. In some embodiments sensors may be placed at various positions on the deployment line itself to provide additional guidance as to the position of the deployment line.

Step 406 comprises determining a catenary profile of each of the deployment lines that matches one or more of the measured characteristics. This may be real-time modeling or predictive modeling. In one embodiment, it may comprise determining a range of tension or position values of the deployment line that match one or more of the measured tension/position characteristics of the deployment line. In one embodiment, a linear or parabolic equation fit or other similar mathematical formulas may be utilized (e.g., a least squares analysis) by one or more computer simulations using standalone time domain finite element (FE) software as is known in the art. In one embodiment, the disclosed modeling techniques utilize formulas similar to those utilized in the commercially available OrcaFlex software, incorporated herein by reference. In one embodiment, determining the modeled catenary shape comprises determining at least one characteristic of the catenary trajectory formed by each deployment line. In another embodiment, determining the modeled catenary shape comprises measuring a plurality of depths of each deployment line at a plurality of known distances from the surface vessel. In one embodiment, the modeled catenary shape comprises a calculated position of substantially all points of the deployment line and/or is substantially all of the deployment line. In other embodiment, the modeled catenary shape determines a plurality of deployment line positions and characteristics at a plurality of points between the subsea device and the surface vessel.

In one embodiment, step 408 comprises determining a value or characteristics of the deployment line that corresponds to the determined catenary profile and/or is based on the determined catenary profile. For example, at a particular point of the deployment line, based on the modeled catenary profile, the cable position (X, Y, Z coordinates), tension, etc. may be determined. After either step 406 or 408, in one embodiment, additional measurements are inputted to further correct and/or model the catenary shape of the deployment line. In one embodiment (not shown), one or more boundary conditions of the subsea device and/or surface vessel may be determined based on determined catenary profiles. Step 410 comprises positioning the subsea device and/or surface vessel based on the modeled catenary shapes of the deployment lines. In one embodiment, the disclosed catenary shapes are output (and/or results thereof are output) to a navigation desk on the surface vessel for real-time monitoring of the catenary shapes.

In an additional embodiment, the disclosed method may further comprise one or more additional steps that models in advance what a catenary shape and/or problem will look like ahead of time based upon a variety of parameter values. This can be based on the measured characteristics as determined in step 404 and the determined catenary profiles as found in step 406. In other words, a similar modeling technique as discussed above may be performed by changing one or more of the input variables (e.g., position of subsea device or surface vessel), and modeling the resulting catenary shape of the deployment lines based on known characteristics and conditions of the deployment line and surface vessel and/or subsea device.

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention.

Many other variations in the catenary modeling system are within the scope of the invention. For example, any one or more of the real time navigation sensors can be weighted differently based on different operational parameters. Multiple subsea equipment deployed at the same time can be tracked at the same time, such as one or more ROVs and one or more node baskets. While one embodiment is directed to deployment of seabed seismic sensors, the catenary determination and modeling of a plurality of deployment lines is applicable to a wide variety of subsea operations. It is emphasized that the foregoing embodiments are only examples of the very many different structural and material configurations that are possible within the scope of the present invention.

Although the invention(s) is/are described herein with reference to specific embodiments, various modifications and changes can be made without departing from the scope of the present invention(s), as presently set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

What is claimed is:

1. A method for the deployment of subsea equipment from a surface vessel, comprising
deploying a first subsea equipment from a surface vessel, wherein the first subsea equipment is connected to the surface vessel by a first deployment line wherein the first subsea equipment is a remotely operated vehicle (ROV);
modeling a catenary shape of the first deployment line;
determining one or more operating parameters for the surface vessel based on the modeled catenary shape; and
deploying a plurality of seismic nodes from the ROV to the seabed based on the modeled catenary shape.

2. The method of claim 1, further comprising determining one or more operating parameters for the first subsea equipment based on the modeled catenary shape.

3. (canceled)

4. The method of claim 1, further comprising
deploying a second subsea equipment from the surface vessel, wherein the second subsea equipment is connected to the surface vessel by a second deployment line;
deploying a third subsea equipment from the surface vessel, wherein the third subsea equipment is connected to the surface vessel by a third deployment line; and
modeling a catenary shape of the second and third deployment lines.

5. The method of claim 4, further comprising
determining one or more operating parameters for the surface vessel based on the modeled catenary shape of the first, second, and third deployment lines.

6. The method of claim 4, wherein the second subsea equipment is a second ROV, and the third subsea equipment is a basket configured to hold a plurality of autonomous seismic nodes.

7. The method of claim 4, further comprising outputting the modeled catenary shapes to an Integrated Navigation System (INS) on the surface vessel for real-time visualization of the deployment lines.

8. The method of claim 1, further comprising measuring a plurality of characteristics of the first deployment line, wherein the modeled catenary shape is based on the measured plurality of characteristics of the first deployment line.

9. The method of claim 8, wherein the plurality of characteristics comprises cable tension, cable length, or cable position.

10. The method of claim 1, further comprising determining the catenary shape based on a plurality of subsea conditions as monitored by a plurality of subsea sensors.

11. The method of claim 1, further comprising positioning the first subsea equipment based on the modeled catenary shape.

12. The method of claim 1, further comprising positioning the surface vessel based on the modeled catenary shape.

13. The method of claim 1, wherein the one or more operating parameters comprises surface vessel speed or heading.

14. The method of claim 1, wherein the modeled shape is a real time position of a plurality of points of the deployment line.

15. The method of claim 1, wherein the modeled shape is a predicted position of a plurality of points of the deployment line.

16. A method for the deployment of seismic nodes to the seabed, comprising deploying a first unmanned underwater vehicle (UUV) from a surface vessel, wherein the first UUV is connected to the surface vessel via a first deployment line, wherein the UUV is configured to deploy a plurality of seismic nodes to the seabed;
deploying a subsea basket configured to hold a plurality of autonomous seismic nodes from the surface vessel, wherein the subsea basket is connected to the surface vessel via a second deployment line;
modeling a real-time catenary shape of the first and second deployment lines;
determining one or more operating conditions for the surface vessel based on the modeled catenary shape of the first and second deployment lines; and
deploying the plurality of seismic nodes from the UUV to the seabed based on the modeled catenary shapes of the first and second deployment lines.

17. The method of claim 16, further comprising modeling a profile of the seabed and analyzing the modeled catenary shapes of the first and second deployment lines in relation to the seabed profile.

18. The method of claim 16, further comprising comparing the one or more operating conditions with a corresponding boundary condition of the surface vessel.

19. A method of modeling a catenary shape of a deployment line, the method comprising:
measuring one or more characteristics of a deployment line, wherein the deployment line is connected to an unmanned underwater vehicle (UUV) and a surface vessel, wherein the UUV is configured to deploy a plurality of seismic nodes to the seabed;
inputting one or more subsea conditions; and
modeling a real-time catenary shape of the deployment line based on the measured characteristics and inputted subsea conditions.

20. The method of claim 19, further comprising determining one or more characteristics of the deployment line based on the modeled catenary shape of the deployment line.
